(19) United States
(12) Patent Application Publication
(10) Pub. No.: US 2024/0116246 A1
(43) Pub. Date: Apr. 11, 2024

(54) MICROTHREE-DIMENSIONAL PRINTING DEVICE

(71) Applicant: JADE BIRD DISPLAY (SHANGHAI) LIMITED, SHANGHAI (CN)

(72) Inventors: Shuai ZHANG, Shanghai (CN); Huiwen XU, Shanghai (CN)

(21) Appl. No.: 18/475,146

(22) Filed: Sep. 26, 2023

(30) Foreign Application Priority Data
Sep. 29, 2022 (WO) PCT/CN2022/122529

(51) Int. Cl. B29C 64/264; B29C 64/124; B33Y 30/00; B33Y 50/02; G02B 26/08

(52) U.S. Cl. CPC B29C 64/264; B29C 64/124; B33Y 30/00; B33Y 50/02; G02B 26/0875; H05B 45/325

(57) ABSTRACT

A micro three-dimensional printing device is provided. The micro three-dimensional printing device includes a micro-LED display projector configured to emit image light; a material platform facing the micro-LED display projector and configured to receive the image light; a movable printing plate configured to hold a three-dimensional printed object; and a moving mechanism connected with the movable printing plate and configured to move the movable printing plate.

### CROSS-REFERENCE TO RELATED APPLICATIONS

The present disclosure claims priority to and the benefits of PCT Application No. PCT/CN2022/122529, filed on Sep. 29, 2022, which is incorporated herein by reference in its entirety.

### TECHNICAL FIELD

The present disclosure generally relates to three-dimensional printing technology, and more particularly, to a micro three-dimensional printing device.

### BACKGROUND

A self-emitting micro-LED display panel, as a micro display module, includes a micro-LED (light emitting diode) array and an IC (integrated circuit) back plane that is connected with each of the micro-LEDs as pixels in the micro-LED array for image display. A diameter of the micro-LED can be made to be less than 5 micro meters by present semiconductor technology, so that the integrity and image quality of the display panel is improved compared with a conventional display panel, such as an LCD (liquid crystal display).

Various technologies are used in manufacturing three dimensional structures. For example, DLP (Digital Light Processing) projectors or laser scanners are used in a three-dimensional printing device to cover a large area, and resin reservoirs are moved correspondingly in an x direction or y direction. However, an alignment process for correcting a tilt, position, and size of the projected image of the DLP projector or the scanners is required. Furthermore, a volume of a three-dimensional printing device cannot be decreased due to the volume of the DLP projector, which is not adapted to microminiaturization of the three-dimensional printing device and is difficult to be applied in a portable device.

The above content is only used to assist in understanding the technical solutions of the present disclosure, and does not constitute an admission that the above is prior art.

### SUMMARY OF THE DISCLOSURE

In order to overcome the drawback mentioned above, the present disclosure provides a micro three-dimensional printing device and manufacture method thereof, so as to reduce a size of the micro three-dimensional printing device.

Embodiments of the present disclosure provide a micro three-dimensional printing device. The micro three-dimensional printing device includes a micro-LED display projector configured to emit image light; a material platform facing the micro-LED display projector and configured to receive the image light; a movable printing plate configured to hold a three-dimensional printed object; and a moving mechanism connected with the movable printing plate and configured to move the movable printing plate.

Many other advantages and features of the present disclosure will be further understood by the following detailed descriptions and the appended drawings.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a structural view of an exemplary micro three-dimensional printing device, according to some embodiments of the present disclosure.

FIG. 2 is a cross-sectional structure of an exemplary micro display module, according to some embodiments of the present disclosure.

FIG. 3 is a cross-sectional structure illustrating an exemplary micro-LED display projector, according to some embodiments of the present disclosure.

FIG. 4 is a schematic illustration of an exemplary image light rotating element, according to some embodiment of the present disclosure.

FIG. 5 illustrates an exemplary rotating transmission lens about an X axis, according to some embodiments of the present disclosure.

FIG. 6 illustrates an exemplary rotating transmission lens about a Y axis, according to some embodiments of the present disclosure.

FIG. 7 illustrates a schematic illustration of an exemplary micro display system, according to some embodiments of the present disclosure.

FIG. 8 illustrates a pixel area of a micro-LED array, according to some embodiments of the present disclosure.

FIG. 9 illustrates positions of pixel sub-images shifting from the objective pixel point in the pixel area, according to some embodiments of the present disclosure.

FIG. 10 illustrates an objective image formed by objective image data, according to some embodiments of the present disclosure.

FIG. 11 illustrates a position of each of the sub-images shifting from the objective image, according to some embodiments of the present disclosure.

FIG. 12 illustrates the positions of the sub-images shifting from the objective image, according to some embodiments of the present disclosure.

FIG. 13 is a formula relationship between a shifting distance of the sub-image from the objective image and a rotation angle of a transmission lens based on a certain axis, according to some embodiments of the present disclosure.

FIG. 14A and FIG. 14B present flow charts illustrating micro-LED image displaying methods, according to some embodiments of the present disclosure.

FIG. 15 illustrates a structural diagram showing a side sectional view of an exemplary micro-LED display panel, according to some embodiments of the present disclosure.

FIG. 16 illustrates a structural diagram showing a top view of the micro-LED display panel shown in FIG. 15, according to some embodiments of the present disclosure.

FIG. 17 illustrates a structural diagram showing a side sectional view of a micro-LED display chip shown in FIG. 15, according to some embodiments of the present disclosure.

FIG. 18 illustrates a structural diagram showing a side sectional view of another exemplary micro-LED display panel, according to some embodiments of the present disclosure.

FIG. 19 illustrates a structural diagram showing a top view of the micro-LED display panel shown in FIG. 18, according to some embodiments of the present disclosure.

FIG. 20 illustrates a structural diagram showing a side sectional view of a variation of the exemplary micro-LED display panel shown in FIG. 18, according to some embodiments of the present disclosure.

FIG. 21 illustrates a structural diagram showing a side sectional view of another variation of the exemplary micro-LED display panel shown in FIG. 18, according to some embodiments of the present disclosure.

FIG. 22 illustrates a structural diagram showing a side sectional view of another variation of the exemplary micro-LED display panel shown in FIG. 18, according to some embodiments of the present disclosure.

FIG. 23 illustrates a structural diagram showing a side sectional view of another exemplary micro-LED display panel, according to some embodiments of the present disclosure.

FIG. 24 illustrates a structural diagram showing a top view of the micro-LED display panel shown in FIG. 23, according to some embodiments of the present disclosure.

FIG. 25 illustrates a structural diagram showing a side sectional view of a variation of the exemplary micro-LED display panel shown in FIG. 23, according to some embodiments of the present disclosure.

FIG. 26 is a cross-sectional structural view of another micro-LED display module, according to some embodiments of the present disclosure.

FIG. 27 is a cross-sectional structural view of another micro-LED display projector, according to some embodiments of the present disclosure;

FIG. 28 is a cross-sectional structural view of another micro-LED display projector, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

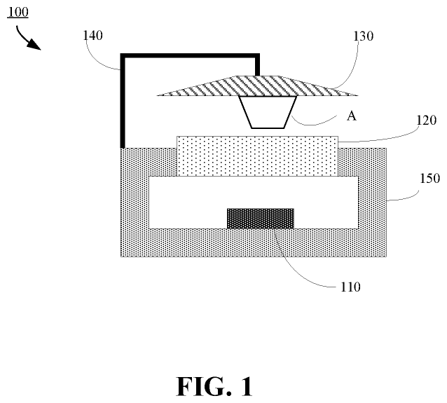

FIG. 1 is a structural view of an exemplary micro three-dimensional printing device 100, according to some embodiments of the present disclosure. As shown in FIG. 1, a three-dimensional printing device 100 includes a micro-LED display projector 110, a material platform 120, a movable printing plate 130 and a moving mechanism 140. Micro three-dimensional printing device 100 further includes a moving controller (not shown) which is electrically connected with moving mechanism 140 and controls the movement of moving mechanism 140. Micro LED display projector 110 emits image light to material platform 120. Material platform 120 faces micro-LED display projector 110 and includes a printing material. Movable printing plate 130 is used for holding a three-dimensional printed object A. Moving mechanism 140 is connected with movable printing plate 130 for moving movable printing plate 130 to face material platform 120 and the three-dimensional printed object A can be printed on movable printing plate 130 when performing the printing process. That is, the printing material can be cured with the image light emitted from micro-LED display projector 110 and formed on a surface of movable printing plate 130, layer by layer. In some embodiments, three-dimensional printing device 100 may be a top-down or bottom-up build orientation three-dimensional printing device. For convenience of description, a bottom-up build orientation three-dimensional printing device is described as an example in the following description.

The printing material in material platform 120 can be selected from one or more photopolymerizable materials. For example, photopolymerizable materials include one or more of free radical photopolymerizable materials, cationic photopolymerizable materials or styrene compounds, vinyl ethers, etc. The free radical photopolymerizable materials can be acrylics, methacrylic, N-vinylpyrrolidone, acrylamides, styrene, olefins, halogenated olefins, cyclic alkenes, maleic anhydride, alkenes, alkynes, etc. In some embodiment, the cationic photopolymerizable materials can be epoxide groups and vinyl ether groups. With the printing material, a three-dimensional object can be formed (e.g., printed) on the surface of movable printing plate 130.

During a printing process, three-dimensional printing device 100 can print a three-dimensional object layer-by-layer. The printing layers may have a same or different thickness. Referring to FIG. 1, in this example, the three-dimensional printed object A is printed on a bottom surface of movable printing plate 130. Moving mechanism 140 can be connected with movable printing plate 130 by one or more mechanical structures such as screws for moving movable printing plate 130, which is not limited herein. After one layer is printed, movable print plate 130 can be moved upward by a layer's distance. Then a next layer of the three-dimensional object can be printed with a following pattern produced by the image light emitted from micro-LED display projector 110. Micro LED display projector 110 can project images/patterns layer by layer until the three-dimensional object is completely printed. It can now be understood that the images/patterns projected by micro-LED display projector 110 correspond to the layers to be printed, and consistent with the movement of movable printing plate 130. In some embodiments, the image light and movement of the movable printing plate can be controlled by a computer program, consistent with the design of the three-dimension object to be printed.

In some embodiments, material platform 120 is transparent. In some embodiments, the emitting light from micro-LED display projector 110 can be transmitted through material platform 120 into the printing material. Referring to FIG. 1, material platform 120 is formed above micro-LED display projector 110. Thus, the emitting light from micro-LED display projector 110 can provide light into the printing material for curing the printing material in a three-dimensional printing process.

The moving controller is electrically connected with moving mechanism 140 for controlling the movement of moving mechanism 140. In the three-dimensional printing process, movable printing plate 130 can be moved by the moving mechanism 140 to face material platform 120 and micro-LED display projector 110. A focal plane of micro-LED display projector 110 is located on a surface of material platform 120, for example, on the bottom surface for the bottom-up printing process or on a top surface for the top-down printing process. In this example, the focal plane of micro-LED display projector 110 is located on the bottom surface of material platform 120.

Micro LED display projector 110 can further include a micro-LED display module for emitting lights with patterns. The micro-LED display module can further include a micro-LED display panel. The micro-LED display panel can be an AM (active matrix) micro-LED display panel or PM (passive matrix) micro-LED display panel. For curing the printing materials, the wavelength of the emitting light from the micro-LED display panel is not more than 4430 nm. In some embodiments, the emitting light is an ultraviolet light.

Still referring to FIG. 1, a pocket holder 150 is further provided to support micro-LED display projector 110 and material platform 120. Micro-LED display projector 110 is provided in pocket holder 150 and material platform 120 is provided on the top of pocket holder 150. With pocket holder 150, micro-LED display projector 110 and material platform 120 can be integrated. Therefore, three-dimensional printing device 100 can be portable. Furthermore, a top opening is formed at the top surface of pocket holder 150 and opposite to micro-LED display projector 110 to receive material platform 120. Material platform 120 is provided in the top opening.

Further details of the micro-LED display projector including a micro-LED display module will be further described hereinafter.

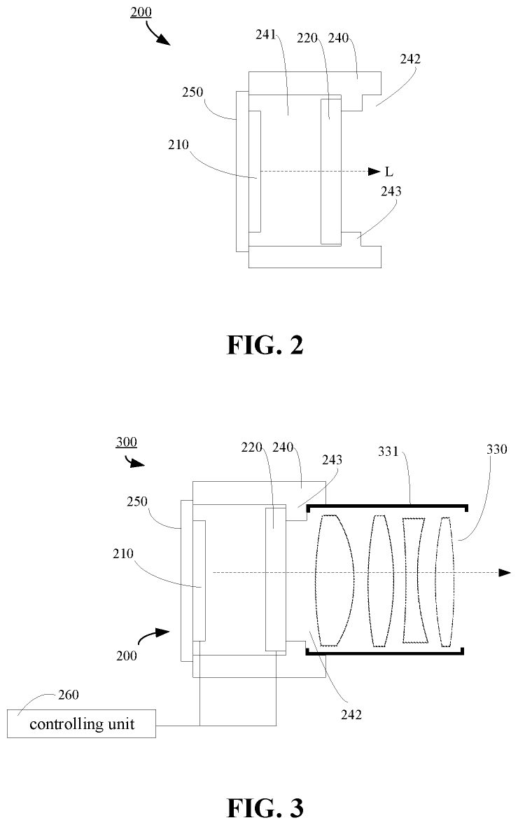

FIG. 2 is a cross-sectional structure of an exemplary micro-LED display module 200, according to some embodiments of the present disclosure. Referring to FIG. 2, micro-LED display module 200 includes a micro-LED display panel 210. Micro LED display module 200 also includes an image light rotating element 220. A stiffening plate 250 is formed at the back of micro-LED display panel 210 for supporting micro-LED display panel 210. A mounting frame 240 connects stiffening plate 250 with image light rotating element 220. Furthermore, mounting frame 240 includes a first chamber 241 and a second chamber 242. Image light rotating element 220 is arranged in first chamber 241, and micro-LED display panel 210 is arranged facing the image light rotating element 220 in first chamber 241. In some embodiments, micro-LED display panel 210 is arranged at an edge of first chamber 241 and an edge of stiffening plate 250 is adhered to one edge of mounting frame 240 by a conventional binder, such as glue or any other adhesive. Additionally, first chamber 241 and second chamber 242 are separated by an inner protrusion 243 protruding from an inner sidewall of mounting frame 240. In some embodiments, inner protrusion 243 is formed on the inner wall of mounting frame 240 as an annular protrusion. In some embodiments, inner protrusion 243 may include a plurality of discrete segments. First chamber 241 and second chamber 242 are connected to form a light channel L through which image light can be emitted, so the protrusion 243 cannot shield the image light emitted from a transmission lens (not shown). The edge of image light rotating element 220 is adhered to one sidewall of inner protrusion 243 by a conventional binder, such as glue or any other adhesive. Micro-LED display panel 210 can further include an IC (integrated circuit) back plane and a micro-LED array area having one or more micro-LEDs. The micro-LED array area is formed on a surface of the IC back plane and each of the micro-LEDs is electrically connected with the IC back plane. In some embodiments, the micro-LED array area is metal bonded with the surface of the IC back plane.

FIG. 3 is a cross sectional structure illustrating an exemplary micro-LED display projector 300, according to some embodiments of the present disclosure. Referring to FIG. 3, micro-LED display module 200 described above can be implanted in micro display projector 300. In some embodiments, micro-LED display projector 300 includes the aforementioned micro-LED display module 200 and a lens group 330. Lens group 330 is arranged facing micro-LED display module 200 for receiving the image light emitted from micro-LED display module 200. Lens group 330 is arranged and supported in a column structure. An edge 331 of the column structure is fixed on mounting frame 240. Furthermore, edge 331 of the column structure is inserted into and adhered to the other sidewall of protrusion 243 in second chamber 242. Additionally, the body of the column structure extends outside of second chamber 242. In some embodiments, a diameter of at least one lens of the lens group 330 is not less than the length of a diagonal line of the micro-LED array area, and not less than the length of a diameter of the transmission lens (not shown). In some embodiments, micro-LED display module 200 further includes a controlling unit 260. Controlling unit 260 is electrically connected to micro-LED display panel 210 and image light rotating element 220.

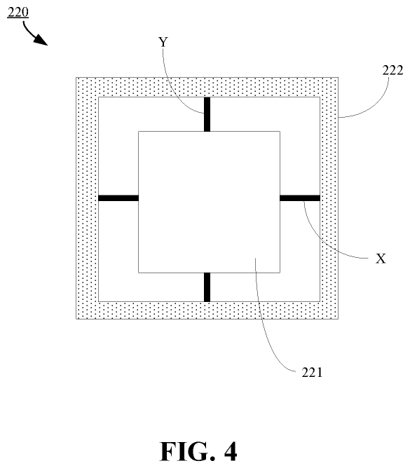

FIG. 4 is a schematic illustration of an exemplary image light rotating element 220, according to some embodiment of the present disclosure. Referring to FIG. 4, image light rotating element 220 includes a transmission lens 221 and a lens position rotating actuator 222. The transmission lens 221 is arranged facing the micro-LED array area, consistent with FIG. 2. Lens position rotating actuator 222 is connected with transmission lens 221 by at least one preset axis. In some embodiments, the preset axis is parallel to the micro-LED array area. In some embodiments, as shown in FIG. 4, the preset axis includes an X axis and a Y axis.

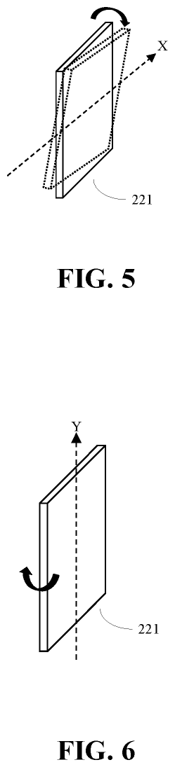

FIG. 5 illustrates transmission lens 221 configured to rotate about an X axis, according to some embodiments of the present disclosure. Referring to FIG. 5, transmission lens 221 can be rotated about the X axis by the lens position rotating actuator (e.g., lens position rotating actuator 222 in FIG. 4). For example, the lens position rotating actuator produces a magnetic field to rotate transmission lens 221 about the X axis, which can be understood by those skilled in the art and will not be described herein. In some embodiments, the X axis is parallel to the micro-LED array area in a first direction.

FIG. 6 illustrates transmission lens 221 configured to rotate about a Y axis, according to some embodiments of the present disclosure. Referring to FIG. 6, transmission lens 221 can further be rotated about the Y axis by the lens position rotating actuator (e.g., lens position rotating actuator 222 in FIG. 2). For example, the lens position rotating actuator produces a magnetic field to rotate the transmission lens 221 about the Y axis, which can be understood by those skilled in the art and will not be described herein. As disclosed herein, the Y axis is parallel to the micro-LED array area in a second direction. The first direction is not parallel with the second direction. In some embodiments, the first direction is perpendicular to the second direction, so the X axis is perpendicular to the Y axis. For example, the X axis is along a horizontal direction and the Y axis is along a vertical direction.

Referring to FIG. 5 and FIG. 6, rotation angles of transmission lens 221 can be designed +X° (about X axis), −X° (about X axis), +Y° (about Y axis) and −Y° (about Y axis). In some embodiments, X° is not more than 15°, and Y° is not more than 15°. In a three-dimensional space, the rotation angles of transmission lens 221 can be (−X°, +Y°), (+X°, +Y°), (+X°, −Y°) and (−X°, −Y°).

In some embodiments, the micro-LED display module further includes an actuator controller electrically connected to lens position rotating actuator 222 for controlling a rotation direction and rotating frequency of lens position rotating actuator 222, so that transmission lens 221 can be rotated at various angle about the X axis and/or Y axis, and the emitting light of each of pixels of micro-LED display panel 210 can be shifted at various positions to increase the resolution ratio of the pixels.

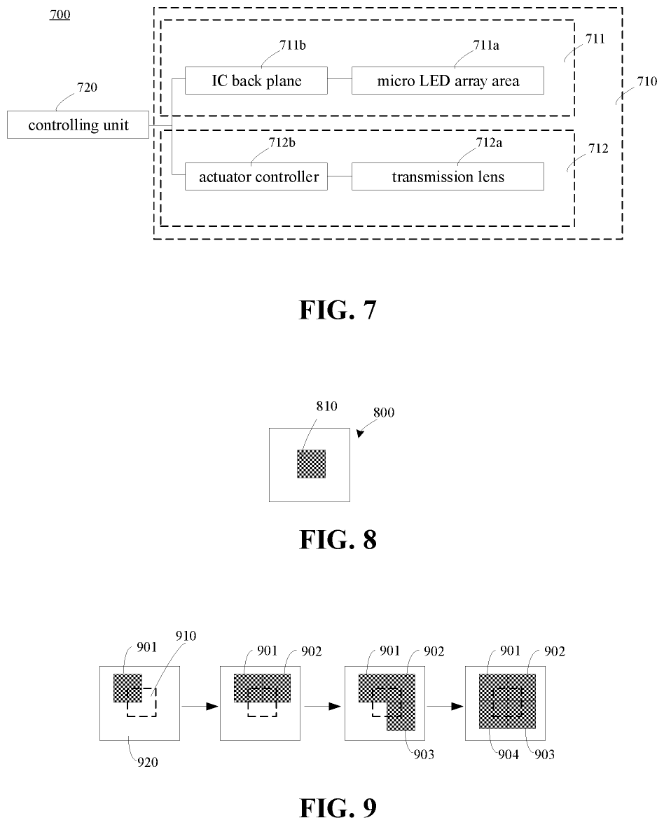

FIG. 7 illustrates a schematic illustration of an exemplary micro display system 700, according to some embodiments of the present disclosure. Referring to FIG. 7, the micro-LED display module as discussed above can be applied in micro display system 700. Micro display system 700 includes a micro-LED display module 710 and a controlling unit 720. Controlling unit 720 is connected to micro-LED display panel 711 and an image light rotating element 712. Micro LED display panel 711 includes a micro-LED array area 711a and an IC (integrated circuit) back plane 711b that is formed such as by metal-bonding at the bottom of the micro-LED array area 711a and electrically connected with each of the micro-LEDs. Image light rotating element 712 includes a transmission lens 712a and an actuator controller 712b. Controlling unit 720 is connected to IC back plane 711b and actuator controller 712b for transmitting signals to IC back plane 711b and actuator controller 712b. Controlling unit 720 is configured to process objective image data to form N pieces of sub-image data and calculate the rotation direction and rotating frequency of transmission lens 712a for each sub-image data according to a refresh frequency of the objective image data, send the rotation direction and rotating frequency to actuator controller 712b, and send the sub-image data and the rotating frequency to IC back plane 711b. Actuator controller 712b is configured to receive the rotation direction and the rotating frequency of transmission lens 712a for each sub-image data. Actuator controller 712b is further configured to control the lens position rotating actuator (not shown) and transmission lens 712a to perform a rotating process based on the rotation direction and the rotating frequency for each sub-image data. IC back plane 711b is configured to synchronously control micro-LED display panel 711 to display a sub-image according to the sub-image data and the rotating frequency.

The sub-image, the shifting position of the sub-image, and relationship between the rotation of the transmission lens and the shifting position of the sub-images are further disclosed in further detail as follows.

Each pixel point in the micro-LED array area is separately formed in a corresponding pixel area, and each pixel area comprises N pieces of pixel sub-images. The pixel sub-image of a pixel point is shifted in a shifting order and in the pixel area of the pixel point. The N-pieces of sub-images are shifted in a same shifting order with the pixel sub-images, wherein N is an integer and not less than two. The rotating frequency of sub-image data is M times a refresh frequency of the objective image data, wherein M is an integer and not less than two. In some embodiments, M is equal to N. In some embodiments, M is an even integer. In some embodiments, the shifting direction is a clockwise direction. A refresh frequency of the objective image data is 5070 Hz. In some embodiments, M can be less than 1, for example, 0.5.

FIG. 8 illustrates an exemplary pixel area 800 of a micro-LED array, according to some embodiments of the present disclosure. Referring to FIG. 8, one initial pixel image without rotation of the transmission lens is illustrated. As shown in FIG. 8, the large block illustrates pixel area 800 and the small block illustrates a pixel point 810 of the pixel area 800 as a dotted small block. FIG. 9 illustrates exemplary positions of the pixel sub-images shifting from the objective pixel point in the pixel area, according to some embodiments of the present disclosure. Referring to FIG. 9, pixel sub-images with the rotating of the transmission lens are illustrated. As shown in FIG. 9, the dotted small block represents the initial pixel point without being shifted in the objective image. The pixel area includes a first pixel sub-image 901 of the pixel point, a second pixel sub-image 902 of the pixel point, a third pixel sub-image 903 of the pixel point, and a fourth pixel sub-image 904 of the pixel point. First pixel sub-image 901 is shifted left-up in the pixel area relative to a pixel point 910 (the dotted block) in an objective image 920. Second pixel sub-image 902 is shifted right-up in the pixel area relative to pixel point 910 in the objective image. Third pixel sub-image 903 is shifted right-down in the pixel area relative to pixel point 910 in the objective image. Fourth pixel sub-image 904 is shifted left-down in the pixel area relative to pixel point 910 in the objective image.

As disclosed herein, in some embodiments, a rotating frequency of the transmission lens is four times a refresh frequency of the objective image data. The rotation angle of the transmission lens is (−X°, +Y°), (+X°, +Y°), (+X°, Y°), (−X°, −Y°) in order, so the sub-images corresponding to each of the rotation angles are displayed from left to right and from up to down in a clock-wise direction.

FIG. 10 illustrates an objective image formed by objective image data, according to some embodiments of the present disclosure. Referring to FIG. 10, an objective image is formed by different gray-scale values of a micro-LED array. The micro-LED array of the micro-LED display panel is a M×N matrix, where M is a positive integer greater than 2, N is a positive integer greater than 2. In some embodiments, the micro-LED array is a 1280×680 matrix. As shown in FIG. 10, four-pixel points (e.g., 1001 to 1004) correspond to four micro-LEDs, which only exemplify the micro-LED array for describing the objective image and sub-images, and are not used to limit the scope of the present disclosure. In some embodiments, a width or a length of the micro-LED display panel is not greater than 5 μm, and a diagonal line of the micro-LED array area is not greater than 5 cm. Therefore, the micro-LED display panel can be designed in a small size.

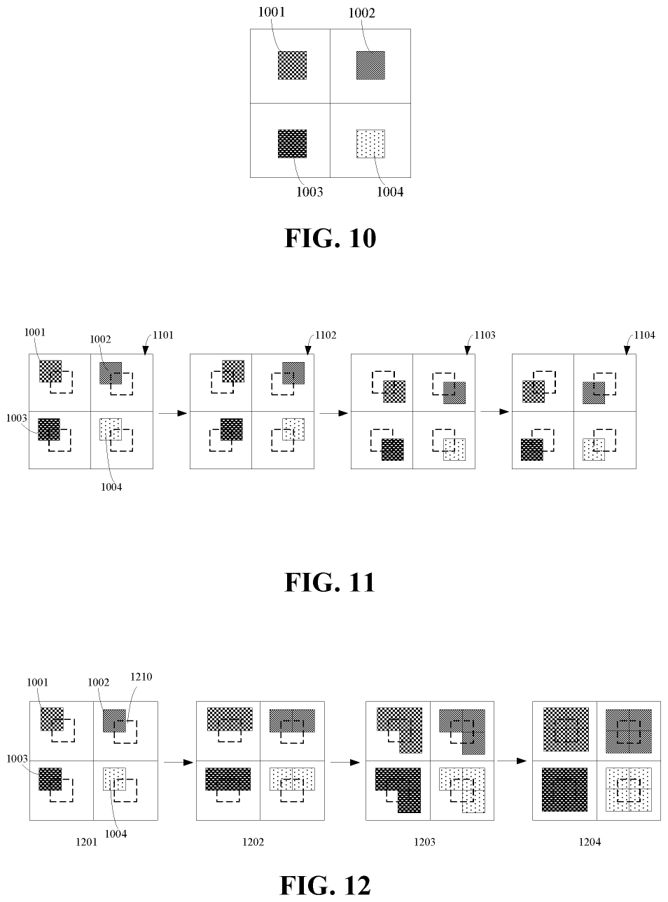

FIG. 11 illustrates an exemplary position of each of the sub-images shifting relative to the pixel point in objective image, according to some embodiments of the present disclosure. Referring to FIG. 11, the objective image data is processed to form four sub-image data: a first sub-image 1101, a second sub-image 1102, a third sub-image 1103, and a fourth sub-image 1104. As shown in FIG. 11, the dotted blocks represent the pixel point of each sub-image in an objective image. The sub-images formed by the sub-image data are separately shown in FIG. 11.

Referring to FIG. 9 and FIG. 11, each of the pixel areas includes first pixel image 901, second pixel image 902, third pixel image 903, and fourth-pixel image 904. First pixel image 901 is shifted left-up in the pixel area relative to the pixel point in the objective image; second pixel image 902 is shifted right-up in the pixel area relative to the pixel point in the objective image; third pixel image 903 is shifted right-down in the pixel area relative to the pixel point in the objective image; and fourth pixel image 904 is shifted left-down in the pixel area relative to the pixel point in the objective image. Therefore, first sub-image 1101 is shifted left-up in the objective image area relative to the objective image; second sub-image 1102 is shifted right-up in the objective image area relative to the objective image; third sub-image 1103 is shifted right-down in the objective image area relative to the objective image; and fourth sub-image 1104 is shifted left-down in the objective image area. The objective image area is the same as the micro-LED array area and not changed in the displaying process.

As shown in FIG. 11, the positions of the sub-images are shifted from left to right and from up to down in a clockwise direction with the rotation of the transmission lens at the rotating angles of (−X°, +Y°), (+X°, +Y°), (+X°, −Y°), (−X°, −Y°) in order. That is, the position of the sub-image is shifted by rotating the transmission lens, and the position of the sub-image is determined by the rotating angle of the transmission lens. In some embodiments, the sub-images formed by the sub-image data are the same as the objective image formed by the objective image data, thereby ensuring the quality of the displayed objective image. Furthermore, the gray-scale values of all of the pixel sub-images of the same pixel point are the same as the gray-scale values of the objective pixel image of the same pixel point in the objective image data, as shown in FIG. 11. In another example, the gray-scale value of at least one of the pixel sub-images of the same pixel point is not the same as the gray-scale of the objective pixel image of the same pixel point in the objective image data. In some embodiments, one pixel corresponds to one micro-LED.

FIG. 12 illustrates the positions of the sub-images shifting relative to the objective image, according to some embodiments of the present disclosure. The controlling unit (e.g., controlling unit 720 in FIG. 7) is configured to send the four sub-image data and the rotating frequency to the IC back plane and send the rotation angles and the rotating frequency to the actuator controller. Referring to FIG. 12, the dashed-line blocks (for example, 1210) represent the pixel point of the objective image. The actuator controller (e.g., actuator controller 712b in FIG. 7) controls the transmission lens rotating at the rotating angles of (−X°, +Y°) based on the rotating frequency, such as 240 Hz, and the IC back plane (e.g., IC back plane 711b in

FIG. 7) controls the micro-LED display panel displaying the first sub-image based on the rotating frequency, as shown in a first objective image 1201. The actuator controller controls the transmission lens rotating at the rotating angles (+X°, +Y°) based on the rotating frequency, and the IC back plane controls the micro-LED display panel displaying the second sub-image based on the rotating frequency as shown in a second objective image 1202. Similarly displaying of the third sub-image is shown in a third objective image 1203 and similarly displaying of the fourth sub-image is shown in a fourth objective image 1204. Because the rotating frequency is very fast, the human eye cannot see transmitting of the four sub-images and only sees a final objective image as shown in fourth objective image 1204 in FIG. 12, which is similar to the picture shown in FIG. 10. The four sub-images are combined together in the clockwise direction to form the final objective image shown in fourth objective image 1204.

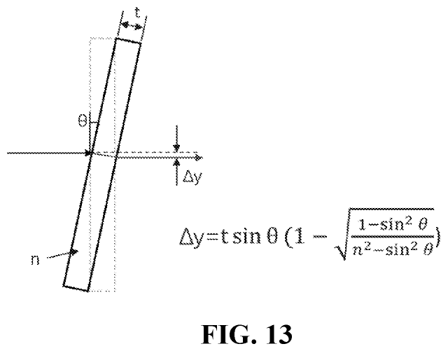

FIG. 13 illustrates a formula relationship between a shifting distance of the sub-image from the objective image and a rotation angle of the transmission lens based on a certain axis, according to some embodiments of the present disclosure. Referring to FIG. 13, the relationship of the shifting distance and the rotation angle is as follows:

$$Δ y = t sin θ ( 1 - \sqrt{\frac{1 - {sin}^{2} θ}{{n}^{2} - {sin}^{2} θ}} ) ;$$

wherein Δy is the shifting distance, θ is the rotation angle, t is the center thickness of the transmission lens, and n is the refraction ratio of the transmission lens. In some embodiments, the shifting distance between the adjacent sub-images is, for example, 50˜100% of the pixel pitch. Therefore, the rotation angle can be calculated by the above formula.

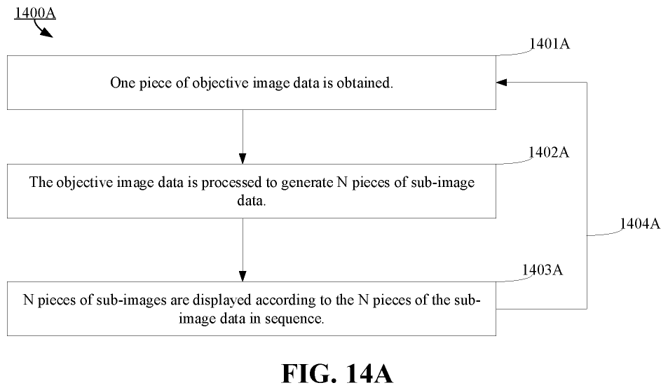

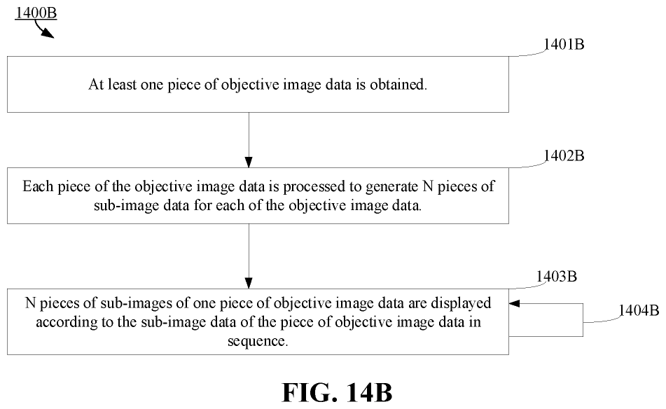

FIG. 14A is a flow chart illustrating a micro-LED image displaying method 1400A, according to some embodiments of the present disclosure. Referring to FIG. 14A, the micro-LED image displaying method 1400A using the aforementioned micro-LED display module includes the following steps 1401A to 1404A.

At step 1401A, one piece of objective image data is obtained. The objective image data can be obtained by a controlling unit, e.g., controlling unit 720, for further operation. In some embodiments, the objective image data can be stored in a memory and can be obtained by the controlling unit via a network. In some embodiments, the memory is an external memory.

At step 1402A, the objective image data is processed to generate N pieces of sub-image data, wherein N is not less than two. For example, four pieces of sub-image data are generated. The four pieces of sub-image data are the same, and the four sub-images formed according to the sub-image data are the same, as shown in FIG. 10.

At step 1403A, N pieces of sub-images are displayed according to the N pieces of the sub-image data in sequence based on the rotating frequency and the preset rotation direction of the transmission lens for each piece of sub-image data, wherein N is an integer and not less than two. Furthermore, a pixel sub-image of a pixel point is shifted in a shifting order and in the pixel area of the pixel point, and the N-piece sub-images are shifted in a same shifting order with the pixel sub-images. The rotating frequency of sub-image data is M times the refresh frequency of the objective image data. In some embodiments, N is an integer and not less than two and M is an integer not less than two. In some embodiments, M is equal to N. In some embodiments, M is an even integer. For example, the rotating frequency of the transmission lens is four times of the refresh frequency of the objective image data. The refresh frequency of the objective image data is, for example, 50˜70 Hz. In this example, the shifting direction is a clockwise direction. The sub-images formed by the sub-image data are as same as the objective image formed by the objective image data.

In some embodiments, the actuator controller is configured to control the transmission lens rotating at the rotating angles of (−X°, +Y°) based on the rotating frequency, such as 240 Hz, and the IC back plane is configured to control the micro-LED display panel displaying the first sub-image 1101 based on the rotating frequency as shown FIG. 11. The actuator controller is configured to control the transmission lens rotating at the rotating angles (+X°, +Y°)based on the rotating frequency and the IC back plane is configured to control the micro-LED display panel displaying the second sub-image 1102 based on the rotating frequency as shown in FIG. 11. Similarly displaying of the third sub-image 1103 and similarly displaying of the fourth sub-image 1104 are also shown in FIG. 11.

In some embodiments, the IC back plane includes an IC driver circuit to drive each of the micro-LEDs. In some embodiments, the IC driver circuit is driven and controlled by a PWM (pulse width modulation) signal and a current source. In some embodiments, a gray-scale value of each of the micro-LEDs is controlled by the PWM signal.

Referring back to FIG. 14A, at step 1404A, the steps 1401A and 1403A are repeated until all of the objective image data is displayed.

For example, a plurality of objective images can be displayed by repeating the steps 1401A to 1403A.

FIG. 14B illustrates another micro-LED image displaying method 1400B, using the aforementioned micro-LED display module, according to some embodiments of the present disclosure. The method 1400B includes the following steps 1401B to 1404B.

At step 1401B, at least one piece of objective image data is obtained.

At step 1402B, each piece of the objective image data is processed to generate N pieces of sub-image data for each of the objective image data.

At step 1403B, N pieces of sub-images of the piece of objective image data are displayed according to the sub-image data of the piece of objective image data in sequence based on the rotating frequency and the preset rotation direction of the transmission lens for each sub-image data, wherein N is an integer and not less than two.

At step 1404B, the sub-images of next objective image data are displayed in sequence by recycling the step 1403B until all of the objective image is displayed.

The details of steps 1402B to 1403B can be referred to the steps 1402A to 1403A, which will not be repeated herein.

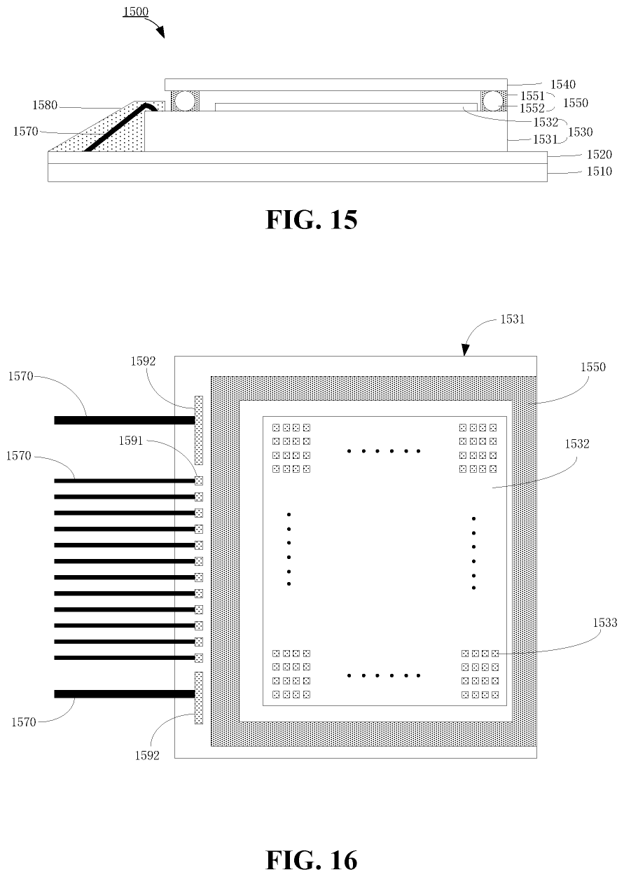

FIGS. 15 to 25 illustrate micro-LED display panels, which can be implanted as display panel 210 in FIGS. 2 and 3. FIG. 15 illustrates a structural diagram showing a side sectional view of an exemplary micro-LED display panel 1500 of a micro-LED display chip, according to some embodiments of the present disclosure. As shown in FIG. 15, the micro-LED display panel 1500 includes a micro-LED display chip 1530, a top cover plane 1540, and a seal structure 1550. The micro-LED display chip 1530 includes a micro-LED array areal 532 and an IC (integrated circuit) substrate 1531. Micro LED array areal 532 is located on IC substrate 1531 to form an image display area of micro-LED display chip 1530. The rest of the area on IC substrate 1531 not covered by micro-LED array area 1532 is formed as a non-functional area. Top cover plane 1540 is provided above micro-LED display chip and supported by seal structure 1550. Top cover plane 1540 covers the image display area (e.g., micro-LED array area 1532) and at least part of the non-function area. Therefore, the light emitted from the image display area transmits upward to the top cover plane 1540. Seal structure 1550 is formed between an edge of micro-LED display chip 1530 and an edge of top cover plane 1540. It can be understood that seal structure 1550 forms a closed area on micro-LED display chip 1530 (more specifically, on IC substrate 1531), and surrounds the image display area (e.g., micro-LED array area 1532). In some embodiments, an outer sidewall of seal structure 1550 is aligned with a sidewall of top cover plane 1540 in a vertical direction. In some embodiments, micro-LED display chip 1530 is a self-emitting micro-LED display chip.

With micro-LED display panel 1500, seal structure 1550 can prevent light emitting from the image display area to outside through a gap between top cover plane 1540 and micro-LED display chip 1530.

In some embodiments, a distance between top cover plane 1540 and micro-LED display chip 1530 (e.g., a distance between a bottom surface of the top cover plane 1540 and a top surface of the micro-LED array area 1532) is not greater than a thickness of micro-LED display chip 1530. For example, the thickness of micro-LED display chip 1530 is 500 μm to 5 μm. In some embodiments, the distance between top cover plane 1540 and micro-LED display chip 1530 (e.g., a distance between a bottom surface of top cover plane 1540 and a top surface of micro-LED array area 1532) is not greater than a thickness of top cover plane 1540. For example, the thickness of top cover plane 1540 is not greater than 1500 μm. More specifically, the thickness of top cover plane 1540 is in a range of 200 μm to 1500 μm. In some embodiments, the distance between top cover plane 1540 and micro-LED display chip 1530 is the same as the thickness of the top cover plane 1540. For example, the distance between top cover plane 1540 and micro-LED display chip 1530 is in a range of 200 μm to 1500 μm. In some embodiments, a distance between top cover plane 1540 and micro-LED display chip 1530 is in a range of 3 μm to 5 μm some embodiments, top cover plane 1540 is transparent. For example, the material of top cover plane 1540 can be organic glass or inorganic glass. In some embodiments, top cover plane 1540 is a glass cover.

In some embodiments, seal structure 1550 is formed on the non-function area of micro-LED display chip 1530. That is, seal structure 1550 connects the IC substrate 1531 and top cover plane 1540. A height of seal structure 1550 can be equal to the distance between top cover plane 1540 and the non-functional area (e.g., a top of IC substrate 1531). In some embodiments, seal structure 1550 can include light absorption material, such as a combination of film forming agent composed of resin and polymer and light sensitive sensitizer. The light absorption material can include a film forming agent. The film forming agent can include one or more of resin, polymer, light-sensitive sensitizer, or a combination thereof. With the light absorption material, seal structure 1550 can further absorb the light emitted from the image display area, so as to improve the image quality.

In some embodiments, seal structure 1550 can include sealant 1551 and a plurality of spacers 1552. Seal structure 1550 can be a combination of sealant 1551 and the plurality of spacers 1552. The material of sealant 1551 can comprise one or more of a resin and a polymer. For example, the resin can be an epoxy resin, and the polymer can be silicone. Spacers 1552 can be small balls with a same diameter. Since sealant 1551 is flowable, top cover plane 1540 can be pressed downwards as close as possible to micro-LED display chip 1530. Therefore, a diameter of the ball can define a height of seal structure 1550, in another words, the distance between top cover plane 1540 and the non-functional area (e.g., a top of IC substrate 1531). Using such seal structure 1550, the distance between top cover plane 1540 and micro-LED display chip 1530 can be efficiently guaranteed or adjusted according to the thickness of spacers 1552 (e.g., the diameter of the balls).

In some embodiments, micro-LED display panel 1500 can further include a support base plane formed under the bottom of micro-LED display chip 1530. The support base plane is rigid, so as to provide a stable base of micro-LED display chip 1530.

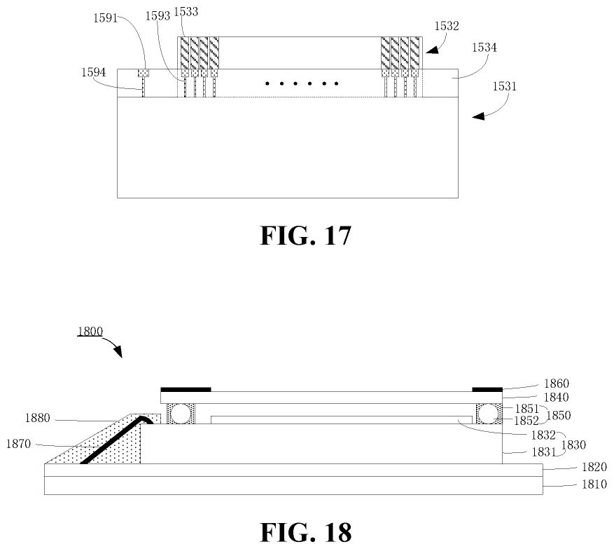

FIG. 16 illustrates a structural diagram showing a top view of micro-LED display panel 1500 shown in FIG. 15, according to some embodiments of the present disclosure. FIG. 17 illustrates a structural diagram showing a side sectional view of micro-LED display panel 1500 shown in FIG. 15, according to some embodiments of the present disclosure. Referring to FIG. 16 and FIG. 17, micro-LED display chip 1530 includes micro-LED array area 1532 and IC substrate 1531 which is formed at the bottom of micro-LED array area 1532 with a portion extending outside of micro-LED array area 1532. Micro LED array area 1532 forms the image display area, and the extending portion of IC substrate 1531 forms the non-functional area. The micro-LED array area 1532 further includes a plurality of micro-LEDs 1533 which are provided in an array. A plurality of signal metal pads and dummy metal can be further formed on a surface of the non-functional area. The signal metal pads can include a plurality of IO (input/output) metal pads 1591 and a plurality of dummy metal pads 1592.

IO metal pads 1591 can conductively connect to IC substrate 1531. Micro LEDs 1533 in micro-LED array area 1532 are connected with IC substrate 1531 by a plurality of first metal connected holes 1593, respectively. That is, every micro-LED 1533 is connected with IC substrate 1531 by one first metal connected hole 1593. Respective tops of first metal connected holes 1593 are connected with micro-LEDs 1533 one-to-one. Accordingly, the plurality of first metal connected holes 1593 correspond to the plurality of micro-LED 1533. As shown in FIG. 16, first metal connected holes 1593 are formed in an array which is the same as the micro-LED array, and first metal connected holes 1593 are formed as a first connected area on IC substrate 1531, which corresponds to the micro-LED array area (e.g., the image display area).Bottoms of the signal metal pads, i.e., IO metal pads 1591 and dummy metal pads 1592, are connected with IC substrate 1531 by a plurality of second metal connected holes 1594. Bottoms of the second metal connected holes 1594 of IO metal pads 1591 are conductively connected with bottoms of first metal connected holes 1593 (by connections not shown). Therefore, IO metal pads 1591 can conductively connect with micro-LEDs 1533 through second metal connected holes 1594, IC substrate 1531, and first metal connected holes 1593. The bottoms of second metal connected holes 1594 of dummy metal pads 1592 are conductively connected with the top electrodes of micro-LEDs 1533. Second metal connected holes 1594 are formed as a second connected area on the non-functional area. The second connected area is spaced from the first connected area, and close to the edge of IC substrate 1531. In some embodiments, the first connected area is referred to as an inside connected area, and the second connected area is referred to as an external connected area. First metal connected holes 1593 and the second metal connected holes 1594 are formed in a top layer 1534 of IC substrate 1531. It is noted that IC substrate 1531 can further include a conventional metal interconnected multilayer to connect IO metal pads 1591 for each micro-LED 1533. The metal interconnected multilayer can be understood by those skilled in the art, which will not be described herein.

Referring to FIG. 15 and FIG. 16, since seal structure 1550 is formed on the non-functional area, the first connected area and the second connected area are further separated by seal structure 1550. For example, the second connected area is formed between seal structure 1550 and the edge of the IC substrate 1531. The second connected area is not covered by seal structure 1550. As shown in FIG. 16, IO metal pads 1591 are formed on the second connected area in a one-dimensional array (e.g., in a line). At least some of dummy metal pads 1592 are formed on the second connected area, which are arranged in a one-dimensional array. In some embodiment, all of dummy metal pads 1592 and IO metal pads 1591 are formed on the second connected area.

Referring to FIG. 15 and FIG. 16, micro-LED display panel 1500 further includes bonding wires 1570. Bonding wires 1570 connect the signal metal pads such as IO metal pads 1591 and dummy metal pads 1592 on the second connected area with an external circuit. Therefore, IC substrate 1531 and micro-LEDs 1533 in micro-LED array area 1532 can be conductively connected with an external circuit by bonding wires 1570. Since only the signal metal pads on the second connected are used to connect with the external circuit, interference of IO metal pads 1591 can be decreased and external design can be facilitated.

Referring back to FIG. 15, in some embodiments, the micro-LED display panel 1500 further includes a protective layer 1580. Protective layer 1580 is formed on a surface of the second connected area and covers around a surface of bonding wires 1570, so as to protect the connection between the second connected area and the external circuit. Bonding wires 1570 can be also be protected by protective layer 1580. In some embodiments, a top of protective layer 1580 is lower than a top of top cover plane 1540. Therefore, protective layer 1580 cannot contact top cover plane 1540. In some embodiments, the top of protective layer 1580 can be lower than a top of micro-LED array area 1532. The material of protective layer 1580 can include resin and polymer. For example, the resin is epoxy resin, and the polymer is silicone. In some embodiments, a sidewall of protective layer 1580 connects to a sidewall of seal structure 1550. Therefore, protective layer 1580 and seal structure 1550 are connected, and there is no non-functional area exposed between protective layer 1580 and seal structure 1550.

In some embodiments, micro-LED display panel 1500 further includes an external circuit plane 1520. An external circuit is formed on external circuit plane 1520. External circuit plane 1520 is formed at the bottom of micro-LED display chip 1530 with a portion extending outside of micro-LED display chip 1530. Protective layer 1580 is further formed on the surface of the extending portion of external circuit plane 1520. In some embodiments, a support base plane 1510 is further formed under the bottom of external circuit plane 1520. Support base plane 1510 is rigid, so as to provide a stable base of micro-LED display chip 1530 and external circuit plane 1520.

In some embodiments, external circuit plane 1520 is formed outside of the bottom of micro-LED display chip 1530, surrounding micro-LED display chip 1530. That is, the circuit plane 1520 and micro-LED display chip 1530 are integrated in a same plane. Therefore, micro-LED display panel 1500 can be more compact. Protective layer 1580 is further formed on the part of external circuit plane 1520. In this example, support base plane 1510 can be formed under external circuit plane 1520 and micro-LED display chip 1530. In some embodiments, external circuit plane 1520 is made by flexible materials. For example, external circuit plane 1520 is made by a flexible printed circuit.

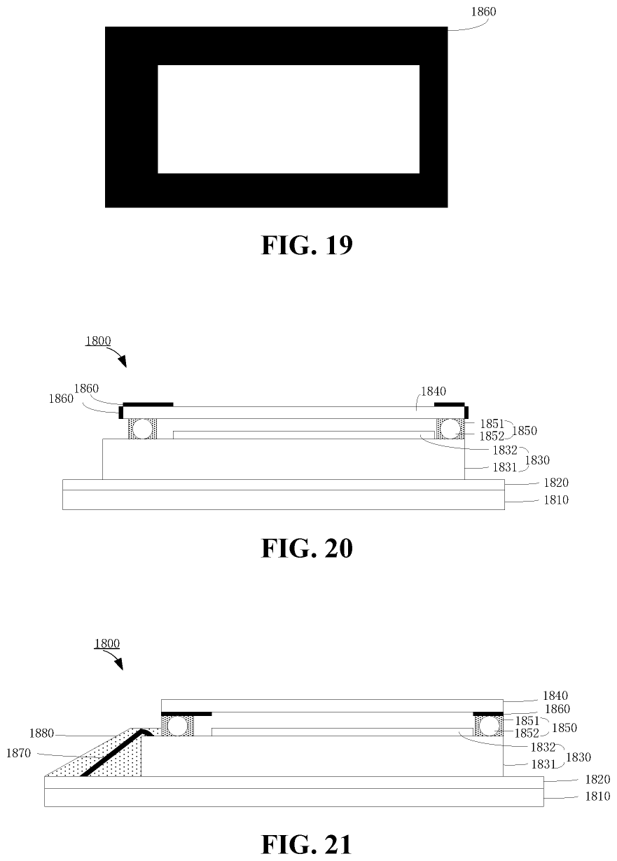

FIG. 18 to FIG. 22 illustrate structural diagrams showing variations of another exemplary micro-LED display panel 1800, according to some embodiments of the present disclosure. Referring to FIG. 18 to FIG. 22, a micro-LED display panel 1800 includes a micro-LED display chip 1830, a top cover plane 1840, and a light shielding layer 1860. The micro-LED display chip 1830 includes a micro-LED array area 1832 and an IC substrate 1831. Micro LED array area 1832 is located on IC substrate 1831 to form an image display area of micro-LED display chip 1830. The rest of the area on IC substrate 1831 not covered by micro-LED array area 1832 is formed as a non-functional area. Top cover plane 1840 is formed above micro-LED display chip 1830. Light emitted from the image display area transmits upward to top cover plane 1840. The light shielding layer 1860 is formed on an edge surface of the top cover plane 1840. It can be understood that light shielding layer 1860 extends along the perimeter of top cover plane 1840. Light shielding layer 1860 can be formed on a top edge surface of top cover plane 1840 (as shown in FIG. 18) or on a bottom edge surface of top cover plane 1840 (as shown in FIG. 21). A projection of light shielding layer 1860 in a vertical direction on micro-LED display chip 1830 covers at least part of the non-functional area. FIG. 19 illustrates a structural diagram showing a top view of micro-LED display panel 1800 of micro-LED display panel shown in FIG. 18 or FIG. 20, according to some embodiments of the present disclosure. As shown in FIG. 19, viewed from the top, light shielding layer 1860 forms around top cover plane 1840, and covers at least part of the non-function area, exposing the image display area. A shape of the light shielding layer 1860 is a closed geometric structure at least exposing the image display area, such as a rectangular frame, a circular frame, an elliptical frame, or any other geometric shape. The shape of light shielding layer 1860 shown in FIG. 19 is a rectangular with an opening at least exposing the image display area. In some embodiments, since the image display area (e.g., micro-LED array area 1832) may not be located at a center of micro-LED display chip 1830, a center of the opening (e.g., a center of the display area or a center of the micro-LED array area 1832) is not aligned with a center of top cover plane 1840.

Therefore, light emitted from the image display area transmitting to top cover plane 1840 where light shielding layer 1860 is formed cannot be reflected back to micro-LED display chip 1830, so as to improve the image quality.

In some embodiments, the projection area of light shielding layer 1860 on the non-functional area covers the IO metal pads and the dummy metal pads. Therefore, there is no light reflected back on the IO metal pads and the dummy metal pads, or further reflected by the IO metal pads and the dummy metal pads outwards from micro-LED display chip 1830. In some embodiments, the projection area of light shielding layer 1860 on the non-functional area further covers the dummy metal that is formed on the non-functional area, so as to prevent the reflection by the dummy metal.

In some embodiments, an outside edge of light shielding layer 1860 is aligned with the sidewall of top cover plane 1840 in a vertical direction. That means light shielding layer 1860 extends to the furthest edge of top cover plane 1840. In some embodiments, an inside edge of light shielding layer 1860 is aligned with a sidewall of the image display area in the vertical direction. Therefore, the projection area of light shielding layer 1860 on micro-LED display chip 1830 covers the non-functional area as much as possible. Furthermore, the projection area of light shielding layer 1860 on micro-LED display chip 1830 covers the whole non-functional area.

In some embodiments, light shielding layer 1860 is an anti-reflection coating layer. For example, the material of the light shielding layer is black photo resist. The thickness of light shielding layer 1860 is not greater than half of the thickness of top cover plane 1840. For example, the thickness of light shielding layer 1860 is in a range of 0.3 μm to 5 μm. Light shielding layer 1860 can be a spinning coat on top cover plane 1840. That is, light shielding layer 1860 is spin coated on top cover plane 1840.

In some embodiments, as shown in FIG. 18, light shielding layer 1860 is formed on a top edge surface of top cover plane 1840. Since top cover plane 1840 is transparent, light shielding layer 1860 on the top edge surface can also prevent reflecting of the transmitted light. FIG. 20 illustrates a structural diagram showing a side sectional view of another variation of the exemplary micro-LED display panel 1800, according to some embodiments of the present disclosure. As shown in FIG. 20, light shielding layer 1860 is further formed on the sidewall of top cover plane 1840 so as to further prevent the light emitted from the image display area from reflecting by the sidewall of top cover plane 1840. The image quality is thereby further improved.

As shown in FIG. 18 and FIG. 20, micro-LED display panel 1800 can further includes seal structure 1850. Seal structure 1850 is formed between the top surface of the non-functional area and a bottom surface of top cover plane 1840, thereby a closed space is formed between micro-LED display chip 1830 and top cover plane 1840 around the image display area. In some embodiments, a distance between micro-LED display chip 1830 and top cover plane 1840 is not greater than a thickness of micro-LED display chip 1830 or a thickness of the top cover plane 1840. A height of seal structure 1850 is equal to a distance between the non-functional area (e.g., a top of IC substrate 1831) and top cover plane 1840 because of a thickness of light shielding layer 1860.

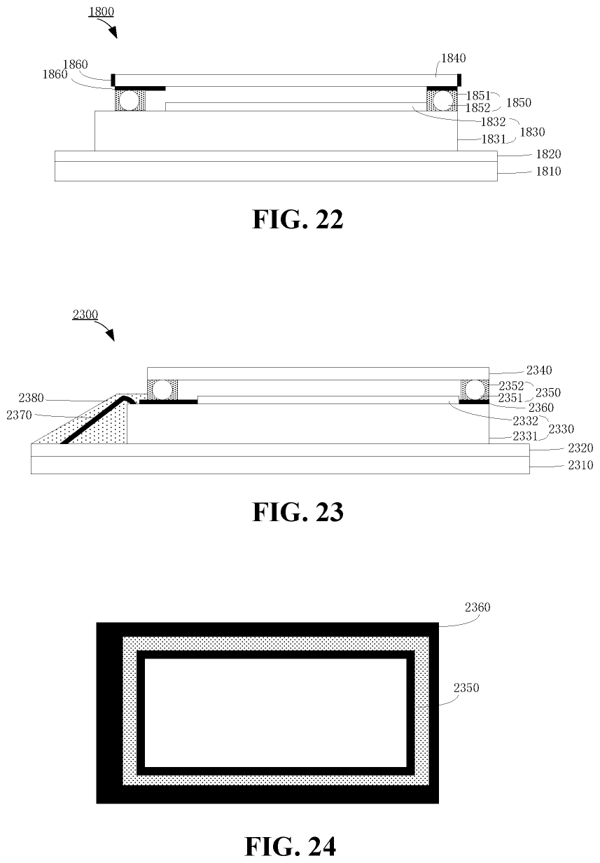

FIG. 21 illustrates a structural diagram showing a side sectional view of another variation of the exemplary micro-LED display panel 1800, according to some embodiments of the present disclosure. As shown in FIG. 21, light shielding layer 1860 is formed on a bottom edge surface of top cover plane 1840. A projection of light shielding layer 1860 in a vertical direction covers at least part of the non-functional area. FIG. 22 illustrates a structural diagram showing a side sectional view of another variation of the exemplary micro-LED display panel 1800, according to some embodiments of the present disclosure. As shown in FIG. 22, light shielding layer 1860 is formed on a bottom edge surface of top cover plane 440, and further formed on a sidewall of top cover plane 1840.

As shown in FIG. 21 and FIG. 22, micro-LED display panel 1800 further includes seal structure 1850. Seal structure 1850 is formed between the top surface of the non-functional area and a bottom surface of light shielding layer 1860 to form a closed space between micro-LED display chip 1830 and top cover plane 1840 around the image display area. In some embodiments, a distance between micro-LED display chip 1830 and top cover plane 1840 is not greater than a thickness of micro-LED display chip 1830 or a thickness of top cover plane 1840. A height of seal structure 1850 is less than the distance between the non-functional area (e.g., a top of IC substrate 1831) and top cover plane 1840 because of a thickness of light shielding layer 1860.

In some embodiments, an anti-reflection material can be integrated at the edge of top cover plane to form a light shielding layer integrated with the top cover plane.

As shown in FIG. 18 to FIG. 22, micro-LED display panel 1800 can further include a support base plane 1810, an external circuit panel 1820, one or more bonding wires 1870, and a protective layer 1880. Further details regarding support base plane 1810, external circuit panel 1820, seal structure 1850, bonding wires 1870, protective layer 1880, and the signal metal pads can be found by referring to the description of the embodiment shown in FIG. 15, which will not be further described here.

FIG. 23 to FIG. 25 illustrate structural diagrams showing variations of another exemplary micro-LED display panel, according to some embodiments of the present disclosure. Referring to FIG. 23 to FIG. 25, a micro-LED display panel 2300 includes a micro-LED display chip 2330, a top cover plane 2340, and a light shielding layer 2360. The micro-LED display chip 2330 includes a micro-LED array area 2332 and an IC substrate 2331. Micro LED array area 2332 is located on IC substrate 2331 to form an image display area of micro-LED display chip 2330. The rest of the area on IC substrate 2331 not covered by micro-LED array area 2332 is formed as a non-functional area. Light shielding layer 2360 is formed on at least part of the surface of the non-functional area. Therefore, the light emitted from the image display area and reflected by top cover plane 2340 to the non-functional area cannot be reflected again. In some embodiments, a top of light shielding layer 2360 is lower than a top of micro-LED display chip 2330 (e.g., a top of the micro-LED array area 2332).

In some embodiments, IO metal pads are further formed on the surface of the non-function area, and light shielding layer 2360 covers the IO metal pads. Therefore, the light reflected to the non-functional area cannot be reflected by the IO metal pads again, so as to improve the micro-LED display panel quality.

In some embodiments, a dummy metal is further formed on the surface of the non-functional area, and light shielding layer 2360 further covers the dummy metal. In some embodiments, light shielding layer 2360 covers the whole non-functional area.

In some embodiments, an outside edge of light shielding layer 2360 is aligned with a part of the sidewall of micro-LED display chip 2330 in a vertical direction. Furthermore, the outside edge of light shielding layer 2360 is aligned with a part of the non-functional area in a vertical direction. In some embodiments, light shielding layer 2360 covers the non-functional area except for one edge surface exposed for connecting bonding wires 2370. In some embodiments, an inside edge of light shielding layer 2360 is aligned with the sidewall of the image display area in a vertical direction. That is, light shielding layer 2360 contacts micro-LED array area 2332. Therefore, light shielding layer 2360 covers the non-functional area as much as possible.

FIG. 24 illustrates a structural diagram showing a top view of the micro-LED display panel shown in FIG. 23, according to some embodiments of the present disclosure. As shown in FIG. 24, viewed from the top, light shielding layer 2360 is formed on the non-functional area of IC substrate 2331, exposing the image display area. A shape of light shielding layer 2360 is a closed geometric structure at least exposing the image display area, such as a rectangular frame, a circular frame, an elliptical frame, or any other geometric shape. The shape of light shielding layer 2360 shown in FIG. 24 is rectangular with an opening at least exposing the image display area.

In some embodiments, light shielding layer 2360 is an anti-reflection coating layer. For example, the material of the light shielding layer is black photo resist. The thickness of light shielding layer 2360 is not greater than half of the thickness of the top cover plane 2340. For example, the thickness of light shielding layer 2360 is in a range of 0.3 μm to 5 μm.

In some embodiments, micro-LED display panel 2300 can further include a seal structure 2350. Seal structure 2350 is formed between the top surface of light shielding layer 2360 and a bottom surface of the edge of top cover plane 2340 around the image display area to form a closed space between micro-LED display chip 2330 and top cover plane 2340 around the image display area. In some embodiments, a distance between micro-LED display chip 2330 and top cover plane 2340 is not greater than a thickness of micro-LED display chip 2330 or a thickness of top cover plane 2340. A height of seal structure 2350 is less than the distance between the non-functional area (e.g., a top of the IC substrate 2331) and top cover plane 2340 because of a thickness of light shielding layer 2360.

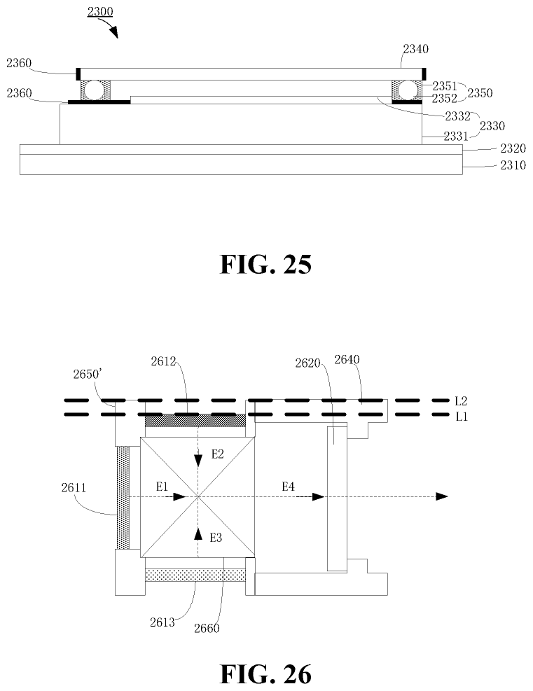

FIG. 25 illustrates a structural diagram showing a side sectional view of another variation of the exemplary micro-LED display panel 2300, according to some embodiments of the present disclosure. As shown in FIG. 25, light shielding layer 2360 can be further formed on a sidewall of top cover plane 2340.

As shown in FIG. 23 to FIG. 25, micro-LED display panel 2300 can further include a support base plane 2310, an external circuit panel 2320, one or more bonding wires 2370, and a protective layer 2380. Further details regarding support base plane 2310, external circuit panel 2320, seal structure 2350, bonding wires 2370, protective layer 2380, and the signal metal pads can be found by referring to the description of the embodiment shown in FIG. 15, which will not be further described here.

FIG. 26 is a cross-sectional structural view of another micro display module, according to some embodiments of the present disclosure. Referring to FIG. 26, the micro-LED display module includes three monochrome micro-LED display panels (e.g., a red micro-LED display panel, a blue micro-LED display panel, and a green micro-LED display panel) 2611, 2612, 2613, and an optical combiner unit 2660 for combining three-color images into one objective image. Three monochrome micro-LED display panels 2611, 2612, 2613, are arranged around the optical combiner unit 2660. A supporting frame 2650′ includes a center chamber and four openings that are around the center chamber. Optical combiner unit 2660 is arranged in the center chamber. Red micro-LED display panel 2611, blue micro-LED display panel 2612, and green micro-LED display panel 2613 are fixed on the edges of three openings, respectively, and the other opening is left for transmitting image light outside. The other opening is arranged facing one of the three openings and facing one (e.g., 2611) of the three micro-LED display panels. The other opening faces the transmission lens, so the image light emitted from the optical combiner unit can transmit into the transmission lens (the arrows represent the transmitting direction of the image light). For example, as shown in FIG. 26, image light E1 emitted from micro-LED display panel 2611, image light E2 emitted from micro-LED display panel 2612, and image light E3 emitted from micro-LED display panel 2613 are combined and transmitted in a transmitting directing E4 by optical combiner unit 2660. As disclosed herein, optical combiner unit 2660 is an optical combiner prism, such as an X-cube. The back surface of a stiffening plate (not shown) is not outside of the edge of supporting frame 2650′. As shown in FIG. 26, dotted line L1 represents the plane of the back surface of the micro-LED display panel 2612, dotted line L2 represents the plane of the edge of the supporting frame 2650′. The micro-LED display module can further include an image light rotating element 2620 and a mounting frame 2640. Further details regarding image light rotating element 2620 and mounting frame 2640 can be found by referring to the description of the embodiment shown in FIGS. 2 and 3, which will not be further described here.

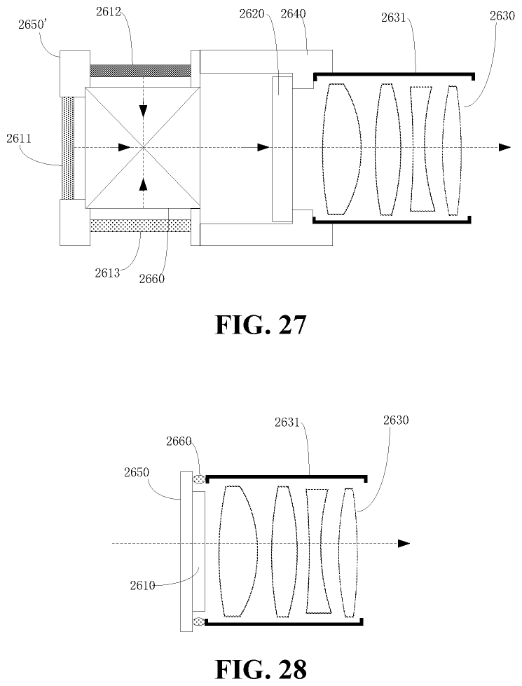

FIG. 27 is a cross-sectional structural view of another micro display projector, according to some embodiments of the present disclosure. Referring to FIG. 27, a micro-LED display projector includes the aforementioned micro-LED display module shown in FIG. 26 and a lens group 2630. Lens group 2630 is arranged facing the X-cube (optical combiner unit 2660) for receiving the combined image light emitted from micro-LED display panel 2611, 2612, and 2613. A length of the diameter of at least one lens of lens group 2630 is not less than a length of the diagonal line of the micro-LED array area. The length of the diameter of at least one lens of lens group 2630 can be less than a width of the X-cube. Further details of the micro-LED display panels, the image light rotating element, and the lens group can be found in the aforementioned description, which is not repeated here.

FIG. 28 is a cross-sectional structural view of another micro display projector, according to some embodiments of the present disclosure. Referring to FIG. 28, a micro-LED display projector includes a stiffening plate 2650, a micro-LED display panel 2610 and lens group 2630. Lens group 2630 is positioned facing micro-LED display panel 2610. The micro-LED display panel 2610 can be found in the description of the aforementioned micro-LED display panel in FIG. 15 to FIG. 25, which will not be repeated herein.

It is understood by those skilled in the art that the micro-LED display module or the micro-LED display panel is not limited by the structure mentioned above, and may include greater or fewer components than those as illustrated, or some components may be combined, or a different component may be utilized.

A size of the micro three-dimensional printing device disclosed herein with the micro-LED display projector can be reduced. The accuracy of the image is improved by the micro-LED display module, thereby improving the performance of the micro three-dimensional print.

The embodiments may further be described using the following clauses:

1. A micro-three-dimensional printing device comprising:
a micro-LED display projector configured to emit image light;
a material platform facing the micro-LED display projector and configured to receive the image light;
a movable printing plate configured to hold a three-dimensional printed object; and
a moving mechanism connected with the movable printing plate and configured to move the movable printing plate.

2. The micro three-dimensional printing device according to clause 1, further comprising a pocket holder configured to support the micro-LED display projector and the material platform, the micro-LED display projector being provided in the pocket holder and the material platform being provided on a top of the pocket holder.

3. The micro three-dimensional printing device according to clause 2, wherein an opening is formed at a top surface of the pocket holder, the material platform being received in the opening.

4. The micro three-dimensional printing device according to any one of clauses 1 to 3, further comprising a moving controller electrically connected with the moving mechanism, and configured to control the moving mechanism.

5. The micro three-dimensional printing device according to any one of clauses 1 to 4, wherein a focal plane of the micro-LED display projector is on a surface of the material platform facing to the micro-LED display projector.

6. The micro three-dimensional printing device according to any one of clauses 1 to 5, wherein a wavelength of the image light is not more than 4430 nm.

7. The micro three-dimensional printing device according to clause 6, wherein the image light is ultraviolet light.

8. The micro three-dimensional printing device according to any one of clauses 1 to 7, wherein the micro-LED display projector further comprises a micro-LED display module for emitting the image light, and a lens group.

9. The micro three-dimensional printing device according to clause 8, wherein the micro-LED display module further comprises at least one micro-LED display panel, wherein the at least one micro-LED display panel comprises an IC (integrated circuit) back plane and a micro- LED array area having one or more micro-LEDs, the micro-LED array area is formed on a surface of the IC back plane and each of the one or more micro-LEDs is electrically connected with the IC back plane.

10. The micro three-dimensional printing device according to clause 9, wherein the lens group is arranged facing the micro-LED display module for transmitting the image light emitted from the micro display module.

11. The micro three-dimensional printing device according to clause 10, wherein a diameter of at least one lens of the lens group is not less than a diagonal line of the micro-LED array area.

12. The micro three-dimensional printing device according to any one of clauses 9 to 11, wherein the micro-LED display module comprises:
three monochrome micro-LED display panels;
an optical combiner unit combining three color images from the three monochrome micro-LED display panels into one objective image, wherein the three monochrome micro-LED display panels are arranged around the optical combiner unit; and
a supporting frame comprising a center chamber and four openings that are around the center chamber;
wherein the optical combiner unit is arranged in the center chamber, each of the three micro-LED display panels is fixed on an edge of three of the openings respectively, a fourth one of the openings is positioned for transmitting the image light outside, and the fourth opening is arranged facing one of the three openings.

13. The micro three-dimensional printing device according to any one of clauses 9 to 12, wherein the micro-LED display panel further comprises:
an external circuit plane formed at a bottom of the IC back plane and electrically connected with the IC back plane via a bonding wire.

14. The micro three-dimensional printing device according to clause 13, wherein the external circuit plane is made by a flexible printed circuit.

15. The micro three-dimensional printing device according to clause 13 or 14, wherein the IC back plane comprises a non-functional area and an inside connected area; the non-functional area is connected with the external circuit plane via the bonding wire; and the inside connected area is connected with the micro-LEDs.

16. The micro three-dimensional printing device according to clause 15, wherein the non-functional area is formed adjacent the inside connected area.

17. The micro three-dimensional printing device according to clause 15, wherein the non-functional area is formed around the inside connected area.

18. The micro three-dimensional printing device according to any one of clauses 15 to 17, wherein the inside connected area comprises a metal connected holes array that is formed in atop layer of the inside connected area; each of the metal connected hole is connected with a different one of the micro-LEDs one by one; and a shape of the metal connected holes array is the same as a shape of the micro-LED array.

19. The micro three-dimensional printing device according to any one of clauses 9 to 18, wherein the IC back plane comprises an IC driver circuit configured to drive each of the micro-LEDs; wherein the IC driver circuit is driven and controlled by a PWM (pulse width modulation) signal and a current source.

20. The micro three-dimensional printing device according to clause 19, wherein a gray-scale value of each of the micro-LEDs is controlled by the PWM signal.

21. The micro three-dimensional printing device according to any one of clauses 9 to 20, wherein the micro-LED display panel is an AM (active matrix) micro-LED display panel or a PM (passive matrix) micro-LED display panel.

22. The micro three-dimensional printing device according to any one of clauses 9 to 21, wherein the micro-LED display projector further comprises a top cover plane covering the micro-LED display panel.

23.The micro three-dimensional printing device according to clause 22, wherein the top cover plane is a glass cover, and a gap is formed between the micro-LED array area and the glass cover.

24. The micro three-dimensional printing device according to any one of clauses 9 to 23, wherein a width or a length of the micro-LED display panel is not greater than 5μm; and a diagonal line of the micro-LED array area is not greater than 5 cm.

25. The micro three-dimensional printing device according to any one of clauses 9 to 24, wherein the micro-LED display module further comprises an image light rotating element, the image light rotating element comprises a transmission lens arranged facing the micro-LED array area and a lens position rotating actuator configured to rotate the transmission lens about at least one preset axis, wherein the preset axis is parallel to the micro-LED array area.

26. The micro three-dimensional printing device according to clause 25, wherein the transmission lens is an optical lens; and the image light emitted from the micro-LED array area passes through the transmission lens and is transmitted outside in a changeable direction corresponding to a rotating direction of the transmission lens.

27. The micro three-dimensional printing device according to clause 26, wherein a diameter of the transmission lens is not less than a length of the micro-LED array area.

28. The micro three-dimensional printing device according to any one of clauses 25 to 27, wherein the micro-LED display module further comprises an actuator controller, electrically connected with the lens position rotating actuator, configured to control a rotation direction and a rotating frequency of the lens position rotating actuator.

29. The micro three-dimensional printing device according to any one of clauses 25 to 28, wherein the lens position rotating actuator is further configured to rotate the transmission lens about an X axis, and the X axis is parallel to the micro-LED array area in a first direction.

30. The micro three-dimensional printing device according to clause 29, wherein the lens position rotating actuator is configured to rotate the transmission lens about a Y axis, and the Y axis is parallel to the micro-LED array area in a second direction; and the first direction is not parallel with the second direction.

31. The micro three-dimensional printing device according to clause 30, wherein the X axis is perpendicular to the Y axis.

It should be noted that relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A micro-three-dimensional printing device comprising:
a micro-LED display projector configured to emit image light;
a material platform facing the micro-LED display projector and configured to receive the image light;
a movable printing plate configured to hold a three-dimensional printed object; and
a moving mechanism connected with the movable printing plate and configured to move the movable printing plate.

2. The micro three-dimensional printing device according to claim 1, further comprising a pocket holder configured to support the micro-LED display projector and the material platform, the micro-LED display projector being provided in the pocket holder and the material platform being provided on a top of the pocket holder.

3. The micro three-dimensional printing device according to claim 2, wherein an opening is formed at a top surface of the pocket holder, the material platform being received in the opening.

4. The micro three-dimensional printing device according to claim 1, further comprising a moving controller electrically connected with the moving mechanism, and configured to control the moving mechanism.

5. The micro three-dimensional printing device according to claim 1, wherein a focal plane of the micro-LED display projector is on a surface of the material platform facing to the micro-LED display projector.

6. The micro three-dimensional printing device according to claim 1, wherein the micro-LED display projector further comprises a micro-LED display module for emitting the image light, and a lens group.

7. The micro three-dimensional printing device according to claim 6, wherein the lens group is arranged facing the micro-LED display module for transmitting the image light emitted from the micro display module.

8. The micro three-dimensional printing device according to claim 6, wherein the micro-LED display module further comprises at least one micro-LED display panel, wherein the at least one micro-LED display panel comprises an IC (integrated circuit) back plane and a micro-LED array area having one or more micro-LEDs, the micro-LED array area is formed on a surface of the IC back plane and each of the one or more micro-LEDs is electrically connected with the IC back plane.

9. The micro three-dimensional printing device according to claim 8, wherein a diameter of at least one lens of the lens group is not less than a diagonal line of the micro-LED array area.

10. The micro three-dimensional printing device according to claim 8, wherein the micro-LED display module comprises:
three monochrome micro-LED display panels;
an optical combiner unit combining three color images from the three monochrome micro-LED display panels into one objective image, wherein the three monochrome micro-LED display panels are arranged around the optical combiner unit; and
a supporting frame comprising a center chamber and four openings that are around the center chamber;
wherein the optical combiner unit is arranged in the center chamber, each of the three micro-LED display panels is fixed on an edge of three of the openings respectively, a fourth one of the openings is positioned for transmitting the image light outside, and the fourth opening is arranged facing one of the three openings.

11. The micro three-dimensional printing device according to claim 8, wherein the micro-LED display panel further comprises:
an external circuit plane formed at a bottom of the IC back plane and electrically connected with the IC back plane via a bonding wire.

12. The micro three-dimensional printing device according to claim 11, wherein the IC back plane comprises a non-functional area and an inside connected area; the non-functional area is connected with the external circuit plane via the bonding wire; and the inside connected area is connected with the micro-LEDs.

13. The micro three-dimensional printing device according to claim 8, wherein the IC back plane comprises an IC driver circuit configured to drive each of the micro-LEDs; wherein the IC driver circuit is driven and controlled by a PWM (pulse width modulation) signal and a current source.

14. The micro three-dimensional printing device according to claim 13, wherein a gray-scale value of each of the micro-LEDs is controlled by the PWM signal.

15. The micro three-dimensional printing device according to claim 8, wherein the micro-LED display projector further comprises a top cover plane covering the micro-LED display panel.

16. The micro three-dimensional printing device according to claim 8, wherein the micro-LED display module further comprises an image light rotating element, the image light rotating element comprises a transmission lens arranged facing the micro-LED array area and a lens position rotating actuator configured to rotate the transmission lens about at least one preset axis, wherein the preset axis is parallel to the micro-LED array area.

17. The micro three-dimensional printing device according to claim 16, wherein the transmission lens is an optical lens; and the image light emitted from the micro-LED array area passes through the transmission lens and is transmitted outside in a changeable direction corresponding to a rotating direction of the transmission lens.

18. The micro three-dimensional printing device according to claim 16, wherein the micro-LED display module further comprises an actuator controller, electrically connected with the lens position rotating actuator, configured to control a rotation direction and a rotating frequency of the lens position rotating actuator.

19. The micro three-dimensional printing device according to claim 16, wherein the lens position rotating actuator is further configured to rotate the transmission lens about an X axis, and the X axis is parallel to the micro-LED array area in a first direction.

20. The micro three-dimensional printing device according to claim 19, wherein the lens position rotating actuator is configured to rotate the transmission lens about a Y axis, and the Y axis is parallel to the micro-LED array area in a second direction; and the first direction is not parallel with the second direction.
